(19) United States
(12) Patent Application Publication
(10) Pub. No.: US 2025/0113810 A1
(43) Pub. Date: Apr. 10, 2025

(54) Fishing rod

(71) Applicant: Protos, LLC, Boise, ID (US)

(72) Inventor: Daniel Martin Uribe, San Antonio, TX (US)

(21) Appl. No.: 18/521,336

(22) Filed: Nov. 28, 2023

Related U.S. Application Data
(62) Division of application No. 29/904,480, filed on Oct. 6, 2023, now Pat. No. D016966.

(51) Int. Cl. A01K 87/00

(52) U.S. Cl. CPC A01K 87/00

(57) ABSTRACT

Disclosed is a fishing rod defined by a smooth transition between an approximately triangular prism at the fishing rod's butt-end and an approximately cylindrical tip.

### CROSS-REFERENCE TO RELATED APPLICATIONS

See Application Data Sheet (ADS). All documents referenced in the ADS are incorporated by reference in their entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of fishing rods.

### Background of the Invention

Fishermen have long relied upon a rod with a body that has the conventional tapering cylindrical design as its structure. However, this prevalent design presents inherent limitations in terms of sensitivity and ergonomic efficiency. The deficiency of this rod design lies in the slow transmission of subtle aquatic stimuli to the angler. Conventional rods, predominantly tapering cylinders, exhibit suboptimal capacity in effectively conveying minute vibrations originating from fish bites or underwater activity. This inadequacy compromises the angler's ability to swiftly and accurately detect such stimuli, ultimately impacting catch rates and angling precision. Further compounding these limitations is the ergonomic deficiency inherent in the standard grip materials affixed to the rear section of the rod. These materials, while serving their purpose, introduce additional weight and fail to provide optimal comfort during extended fishing sessions, thus necessitating a reimagining of the rear handle configuration.

### SUMMARY OF THE INVENTION

In response to these constraints, a novel fishing rod design emerged, conceived to surmount the deficiencies of conventional counterparts. The innovative rod structure features a seamless transition from an approximately triangular prism at the butt-end to an approximately cylindrical tip, deliberately engineered to optimize acoustic vibration transmission along the rod's blank.

The distinct geometry of the rear handle, shaped in a triangular configuration, serves dual purposes. Primarily, it alleviates the ergonomic shortcomings associated with conventional rear grips, providing an unparalleled level of comfort during prolonged use. Secondly, this design innovation eliminates the need for supplementary grip materials, thereby significantly reducing overall rod weight without compromising structural integrity.

The conceptualization and subsequent realization of this revolutionary fishing rod epitomize a departure from conventional paradigms. It is underpinned by a meticulous fusion of scientific principles in material science, acoustics, and ergonomic engineering, culminating in an instrument poised to redefine the benchmarks of angling equipment.

This innovation represents not merely an incremental advancement but a paradigm shift in fishing rod design—a transformation that harmonizes technical precision with enhanced angling proficiency, heralding a new era in the pursuit of piscatorial excellence.

In view of the forgoing it is an objective of this specification to disclose a fishing rod with an innovative design. Specifically, a fishing rod is disclosed that boasts a distinctive construction, where the rod transitions seamlessly as the body tapers from an approximately triangular prism at the butt-end to an approximately cylindrical tip. It is another objective to disclose a fishing rod with a single-piece construction. In particular, the single-piece triangular prism and cylindrical build are optimized to enhance acoustic vibration transmission, thereby significantly amplifying sensitivity throughout the rod's blank, which may be important to detecting bites or nibbles on bait and line during use. Relatedly, it is an objective to discloses a fishing rod with enhanced sensitivity to nibbles and tugs by fish on lined bait attached to the rod. In this instance, the rear handle's triangular shape not only offers unparalleled comfort in grip but also eliminates the necessity for additional grip materials or secondary components. The larger section of the triangular butt end generates an acoustic echo, intensifying sensitivity to bites, leading to quicker and more precise fish detection, ultimately resulting in a higher catch rate. Yet another objective is a fishing rod with a lightweight design. Omitting the need for a rear grip reduces unnecessary weight, resulting in a remarkably lightweight one-piece rod design, ensuring ease of handling and reduced fatigue during extended fishing sessions.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is a perspective view of a fishing rod;

FIG. 2 is a bottom view of the fishing rod;

FIG. 3 is a top view of the fishing rod;

FIG. 4 is a first side view of the fishing rod;

FIG. 5 is a second side view of the fishing rod;

FIG. 6 is a third side view of the fishing rod;

FIG. 7 is a fourth side view of the fishing rod; and,

FIG. 8 is an environmental view of the fishing rod showing the real mount or seat and line guides or eyelets along the fishing rod blank.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFFERED EMBODIMENTS

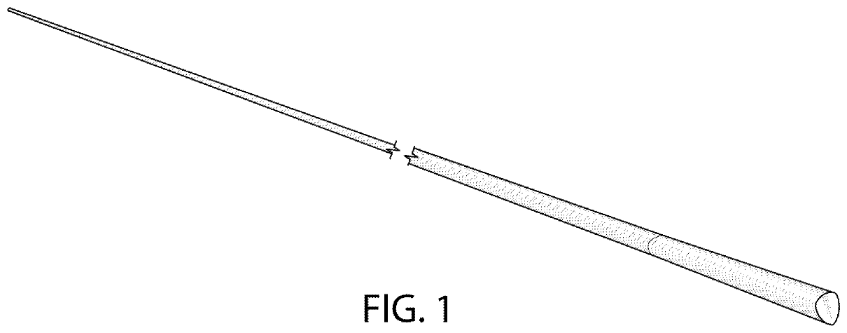

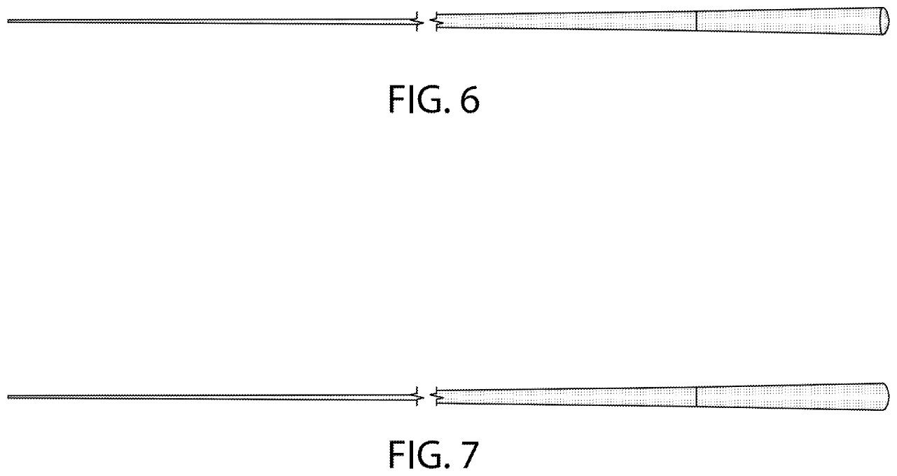

Disclosed is A fishing rod comprising: a fishing rod blank defined by an approximately triangular prism at a butt-end and an approximately cylindrical tip at another end; and, wherein the rod blank features an approximately smooth and tapering transition between the triangular prism at the fishing rod's butt-end and the approximately cylindrical tip. The attached figures (FIGS. 1-8) demonstrate the various views of the fishing rod, showcasing its unique shape, seamless transition from the triangular prism to the cylindrical tip, ergonomic triangular handle, and overall design features.

FIG. 1 is a perspective view of a fishing rod. This perspective view showcases the complete fishing rod, highlighting its innovative design with a seamless transition from an approximately triangular prism at the butt-end to an approximately cylindrical tip. The figure accentuates the ergonomic triangular handle, indicating the comfortable grip and the absence of additional grip materials.

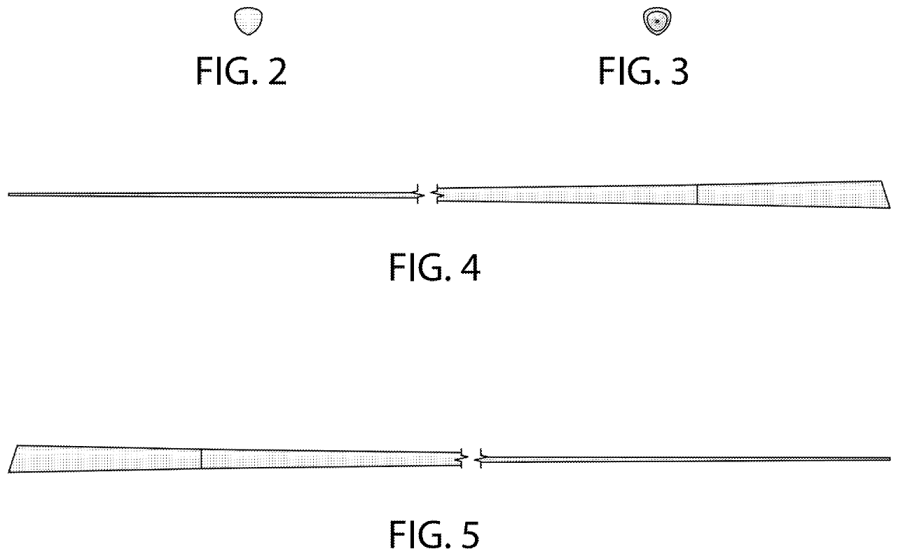

FIG. 2 is a bottom view of the fishing rod. The bottom view provides a detailed perspective of the fishing rod's underside. It illustrates the specific contours and dimensions of the triangular prism at the rod's butt-end, emphasizing the unique shape that aids in acoustic vibration transmission and ergonomic grip.

FIG. 3 is a top view of the fishing rod. The top view offers an overhead perspective, emphasizing the transition from the triangular prism to the cylindrical tip. It highlights the rod's single-piece construction and the optimized design for enhanced sensitivity along the rod's blank.

FIGS. 4 through 7 are side views of the fishing rod. These side views showcases four profiles of the rod, exhibiting the smooth transition from the wider triangular prism to the cylindrical body. It emphasizes the absence of rear grip material and the resultant lightweight construction.

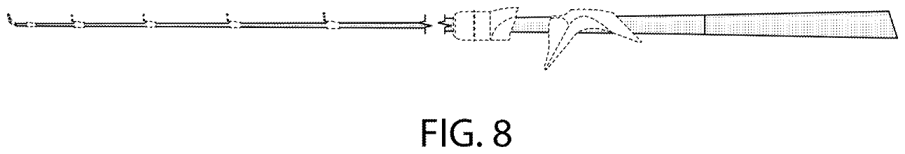

FIG. 8 is an environmental view of the fishing rod. This environmental view provides a comprehensive perspective, showcasing the rod's real mount or seat and line guides or eyelets along the fishing rod blank. It demonstrates how the innovative rod design integrates with standard fishing reel mounts and guides, enhancing its practicality for anglers.

In summary the fishing rod has several advantages:

Superior Sensitivity: Amplified vibration transmission for heightened sensitivity, enabling quicker detection of fish bites.
Comfortable Grip: The triangular rear handle offers an ergonomic and comfortable grip, eliminating the need for additional grip materials.
Lightweight Build: The absence of a rear grip results in a lighter rod, enhancing maneuverability and reducing fatigue during prolonged use.

The rod seems addresses key aspects of fishing rod design, potentially revolutionizing anglers' experiences by providing heightened sensitivity, enhanced comfort, and a lightweight design for improved performance and increased catch rates.

Although the method and apparatus is described above in terms of various exemplary embodiments and implementations, it should be understood that the various features, aspects, and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more,” or the like; and adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to,” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts, and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A fishing rod comprising:
a fishing rod blank defined by an approximately triangular prism at a butt-end and an approximately cylindrical tip at another end; and,
wherein the rod blank features an approximately smooth and tapering transition between the triangular prism at the fishing rod's butt-end and the approximately cylindrical tip.
